(19) United States
(12) Patent Application Publication
(10) Pub. No.: US 2006/0250932 A1
(43) Pub. Date: Nov. 9, 2006

(54) Optical information storage unit

(75) Inventor: Hendrik Van Houten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/539,326

(22) PCT Filed: Dec. 2, 2003
(86) PCT No.: PCT/IB03/05700

§ 371 Date: Jun. 15, 2005

(30) Foreign Application Priority Data
Dec. 20, 2002 (EP) 02080524.8

(51) Int. Cl. G11B 7/00

(52) U.S. Cl. 369/111

(57) ABSTRACT

An optical information storage unit and a reader for such a unit are described. The optical information storage unit comprises an information layer and a readout layer. The information layer has a plurality of data areas. Each data area is arranged to emit light when illuminated by light at a predetermined wavelength. The readout layer has a plurality of optical apertures. Each optical aperture is arranged to image substantially the near field of light emitted from a respective data area.

### FIELD OF THE INVENTION

The present invention relates to an information storage unit, and in particular an information storage unit that can be read by an optical signal, as well as a reader for the unit, methods of reading from and writing to the unit, and methods of manufacture of both the unit and the reader.

### BACKGROUND TO THE INVENTION

Optical information storage media are relatively inexpensive to manufacture in terms of the cost per bit of information stored, compared with solid state storage devices. The key reason is that the optical media (such as optical disks, including compact discs and digital versatile discs) are replicable in a one mask process, on a relatively low cost, plastic substrate.

In comparison, solid state memories typically require a ten mask process, and a relatively expensive, defect free, silicon substrate. Due to the low cost nature of the replication process, optical information carriers, such as CD-ROMs (Compact Disc-Read Only Memories), are particularly suitable for use as publishing media e.g. to distribute software, images and/or sound.

Unfortunately, the drives required to read optical media such as optical disks are relatively large, consume a large amount of power and are vulnerable to shock and vibration. Consequently, many optical storage systems use a removable information carrier i.e. the information carrier may easily be separated from the reader device, so as to allow the easy distribution of the low cost carrier.

Various attempts have been made to provide new types of removable storage medium, which combine the advantages of optical storage (replicability, suitability as distribution medium) with those of solid state storage units (low power, rapid access, high data rates, relatively robust).

One example of an optical memory card system without moving parts is manufactured by Ioptics Incorporated, under the product name OROM, and described within U.S. Pat. No. 5,696,714. The product OROM provides a 128 MB (Mega Byte) card, measuring 59 mm by 46 mm by 2 mm. The card is made of a polycarbonate plastic, similar to that used to manufacture CD-ROMs. The data layer is separated into 5000 discrete data patches, each contains 32 kB of data. Micro-diffractive lenses are molded into a plastic lens array, each lens aligned with a respective data patch. A selection mechanism is utilized to image a specific data patch onto an image sensor.

Whilst the OROM system has the advantage that it has no moving parts, the imaging system is relatively bulky, and the card is relatively large for the information storage capacity it provides.

Multi-layer card systems have been proposed, in which laser beams are selectively coupled to individual layers, utilizing total internal reflection to guide the laser light to a selected layer, micro-holograms to selectively couple light out of the layer, and with the resulting beams being imaged onto an image sensor. However, a multi-layer card is difficult to manufacture, and thus would be relatively expensive. Further, the addressing and selection of an individual layer is usually quite problematic, and is likely to result in relatively expensive reader devices.

It is an aim of embodiments of the present invention to provide an optical information storage system that addresses one or more of the problems of the prior art, whether referred to herein or otherwise.

It is further an aim of embodiments of the present invention to provide an optical information storage system that provides a relatively high information storage capacity per unit area.

### STATEMENTS OF THE INVENTION

In a first aspect, the present invention provides an optical information storage unit comprising: an information layer comprising a plurality of data areas, each data area being arranged to emit light when illuminated by light at a predetermined wavelength; and a readout layer comprising a plurality of optical apertures, each optical aperture being arranged to image substantially only the near field of light emitted from a respective data area.

Diffractive effects associated with far field interactions of light with apertures in opaque bodies. By providing a read out layer having apertures arranged to image substantially only the near field of light from a respective data area, the diffractive effects can be substantially ignored. Hence the area of each data area can be decreased (and may be even less than the wavelength of light) so as to provide a relatively high information storage capacity per unit area. Further, as the readout layer is positioned so that the apertures image the near field of the data areas, this intrinsically leads to a thin storage unit, which does not require a bulky imaging system to be read.

In another aspect, the present invention provides a reader for an optical information storage unit, the reader being arranged to removably receive an optical information storage unit described above, the reader comprising: a light source arranged to provide light at the predetermined wavelength for illumination of the data areas; and an optical sensor comprising a plurality of light sensing areas, the optical sensor being arranged to detect the near field of light imaged by a respective optical aperture.

In a further aspect, the present invention provides an information processing system comprising at least one of: an optical information storage unit as described above, and a reader as described above.

In a further aspect, the present invention provides a method of reading information from an optical information storage unit, the information storage unit comprising: an information layer comprising a plurality of data areas, each data area being arranged to emit light when illuminated by the light at a predetermined wavelength; and a readout layer comprising a plurality of optical apertures, each optical aperture being arranged to image substantially only the near field of light emitted from a respective data area; the method comprising: illuminating at least one data area with light at the predetermined wavelength; and detecting the optical intensity of light imaged by the respective optical aperture that corresponds to the illuminated data area.

In another aspect, the present invention provides a method of manufacturing an optical information storage unit, the method comprising the steps of: providing an information layer comprising a plurality of data areas, each data area being arranged to emit light when illuminated by light at a predetermined wavelength; and providing a readout layer comprising a plurality of optical apertures, the readout layer being located at a distance from the information layer such that each optical aperture is arranged to image substantially only the near field of light emitted from a respective data area.

In a further aspect, the present invention provides a method of writing data to an optical information storage unit, the information storage unit comprising an information layer comprising a plurality of data areas, each data being modifiable so as to emit light when illuminated by the light of predetermined wavelength, and a readout layer comprising a plurality of optical apertures, each optical aperture being arranged to image substantially only the near field light emitted from the respective data area; the method comprising: selectively modifying at least one data area so as to emit light at a predetermined intensity when illuminated, the predetermined intensity being indicative of the information stored by the respective data area.

In another aspect, the present invention provides a method of manufacturing a reader for an optical information storage unit, the method comprising: providing a locator unit arranged to removably receive an optical information storage unit as described above; providing a light source arranged to provide light at the predetermined wavelength for illumination of the data areas of the storage unit; and providing an optical sensor comprising a plurality of light sensing areas, the optical sensor being arranged to detect the near field of light imaged by each respective optical aperture of the storage unit.

### BRIEF DESCRIPTION OF DRAWINGS

For a better understanding of the invention, and to show how embodiments of the same may be carried into effect, reference will now be made, by way of example, to the accompanying diagrammatic drawings in which:

FIG. 1 shows a cross sectional view of an information storage system comprising an information card and a reader in accordance with a first embodiment of the present invention;

FIG. 2 shows a plan view of the readout layer of the card shown in FIG. 1;

FIG. 3 shows a plan view of the information layer of the card shown in FIG. 1;

FIG. 4 shows a cross sectional view of an information storage system comprising an information card and a reader in accordance with a second embodiment of the present invention; and

FIG. 5 shows a cross sectional view of an information storage system comprising an information card and a reader in accordance with a third embodiment of the present invention.

### DETAILED DESCRIPTION OF PREFERRED EMBODIMENTS

Near-Field Scanning Optical Spectrometry (NSOM), also referred to as Scanning Near-Field Optical Microscopy (SNOM), can use a sub-wavelength aperture (in combination with an optical detector) to image a surface at sub-wavelength optical resolution. The spatial resolution is determined by the size of the sub-wavelength aperture in the probe tip. Typically, the probe is scanned over a sample by using a combination of piezo-electric transducers and stepping motors, to obtain light optical images of the surface at sub-wavelength resolution. In other words, the probe samples only the “near-field” of the light from the surface, rather than the “far-field” light, and thus the resolution of the probe is not limited by diffraction effects associated with the far-field.

The present inventor has realized that, by providing an appropriate structure, the physics of near-field coupling can be utilized in optical information storage systems to provide a compact, high information density storage unit.

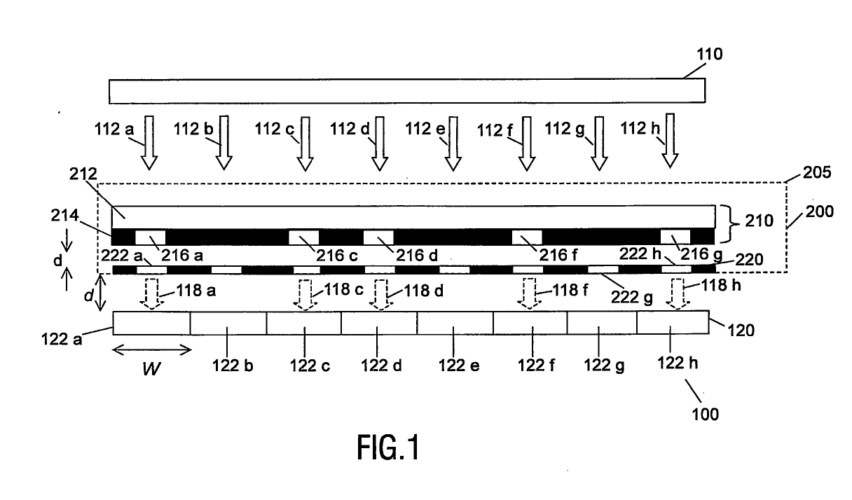

FIG. 1 shows a cross sectional view of a first embodiment of an optical information storage unit 200 within a reader 100.

The information storage unit 200 in this instance is a removable optical memory card. The card consists of a sealed but optically transparent cartridge 205 enclosing an information layer 210 and a readout layer 220.

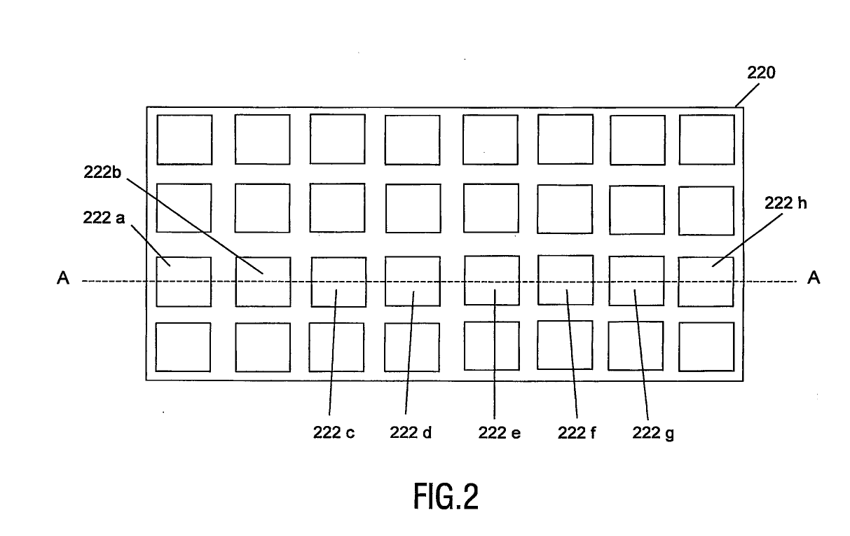

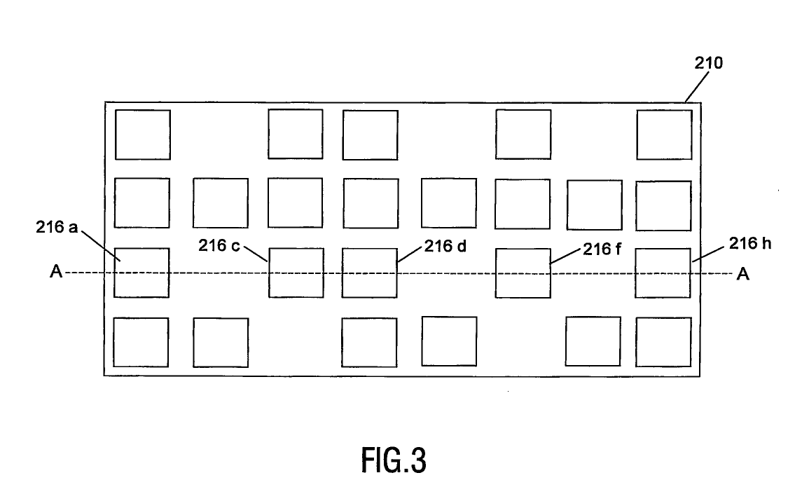

FIG. 2 shows a plan view of the readout layer 220, and FIG. 3 shows a plan view of the information layer 210. In FIGS. 2 and 3, the dotted line AA indicates the plane of the cross sectional view shown in FIG. 1.

The readout layer 220 comprises an optically opaque substrate. An array of optical apertures (e.g. 222a, 222b, . . . 222h) is provided, the apertures allowing light to be transmitted through the readout layer 220.

The information layer 210 in this instance comprises a transparent layer 212 overlaid by an optically opaque covering layer 214. The transparent layer 212 is used to supply mechanical strength to the information layer 210, and could be omitted if desired.

In this embodiment, pits or data areas (e.g. 216a, 216c, 216d, 216f, 216g) are formed at predetermined locations through the opaque layer, thus allowing light to be transmitted through the layer 214 at the pit locations. In this particular embodiment, the pits or data areas have a range of possible locations, each of the possible locations corresponding to a position of an aperture 222 within the readout layer 220. A binary system is used, such that the presence or absence of a pit at the potential location is used to represent information.

Within the card, the information layer is placed substantially parallel to, but separated from, the readout layer 220. The layers 210, 220 are aligned so that the positions of the apertures 222 are substantially aligned with the positions of potential locations of the pits 216 within the opaque coating 214.

The reader 100 comprises a light source 110 and an optical sensor 120. The light source 110 can, for instance be a laser or an LED (Light Emitting Diode, or an array of such devices). The light source is arranged to provide light at a predetermined range of wavelengths, or at a single wavelength λ.

It should be noted that in the specification, the term light is used to indicate any Electro-magnetic radiation, including visible light, infra red and ultra violet wavelength ranges. Further, the terms opaque and transparent are used in the context that the relevant materials substantially block or substantially transmit the passage of light at the relevant wavelengths utilized to read the device.

In this embodiment, the light source 110 provides light at wavelength λ over the complete area of a surface of the information layer. For convenience, the light 112 is indicated by discrete arrows (112a, 112b, . . . 112h) corresponding to the locations of the optical apertures 222 within the readout layer 220.

The optical sensor 120 in this embodiment comprises an array of light sensing areas or pixels. Each light sensing area corresponds to a respective potential position of a pit or data area The image sensor can, for instance, be either a CCD (Charge Coupled Device) or CMOS (Complimentary Metal Oxide Semi-conductor) optical sensor.

In order to ensure that each optical aperture 222 effectively and predominantly images the near-field of light transmitted through the relevant pit or data area 216, the readout layer 220 is separated from the opaque layer 214 by a distance δ, where δ<λ. Spacers may be used within the card 205 to maintain this separation. Each of the n×m array of transparent apertures 222 (where n and m are integers) are also dimensioned (i.e. have a width, length or diameter) to be less than the wavelength of the light that will be emitted from the data areas 216 (which in this instance corresponds to the same wavelength as the illuminating light 112), and is preferably of similar size to the separation δ between the layer. Preferably, each of the pits or data areas is also of width (or, if the data areas are circular, diameter) less than λ.

The spacing of the apertures 222 is chosen to be identical to the pixel pitch W of the image sensor. In typical CCD devices, the pixel pitch is of the order of several micrometers. The spacing d between the cartridge 205 and the image sensor 120 is chosen to be large enough to allow the card to be removable from the reader. Preferably, the readout layer 220 is an integral bottom portion of the cartridge, so as to minimize the thickness of the cartridge 205.

When being read, light is transmitted from the light source 110 towards the card 205. At the locations where the data areas or pits are formed in the opaque layer 214, light is transmitted through the layer, and the near-field of this light subsequently imaged by the relevant optical aperture 222, with the resulting optical signal from the optical aperture 222 (e.g. 118a, 118c, 118d, 118f & 118h) being detected by the relevant pixel 122 of the image sensor 120.

The image sensor 120 can thus detect, by determining the light intensity incident on a relevant pixel, whether an optical pit exists in the corresponding position in the opaque layer 214.

It will be appreciated that the above embodiment is described by way of example only, and that various alternatives will be apparent to the skilled person as falling within the scope of the present invention.

For instance, the optical sensor may be of substantially the same size as the readout layer. However, alternatively a smaller image sensor can be utilized, and the data read by using stepping means to sequentially moving either the card 205 or the sensor 120, so that the sensor scans different portions of the card.

In the above embodiment, the information storage unit 200 has been described as a removable card 205. However, it will be appreciated that the information storage unit need not be removable from the reader, but rather the reader could form an integral part of the information storage unit if desired.

In the above embodiment, each data area corresponds to a pit within the opaque covering layer, with the presence or absence of a pit at a location indicating the information. However, a range of other embodiments would fall within the scope of the present invention. For instance, pits of different sizes (i.e. width, lengths or diameters) could be used to provide a grey-scale, such that different levels of light intensity received at the detector (corresponding to the differently sized pits) indicate different information.

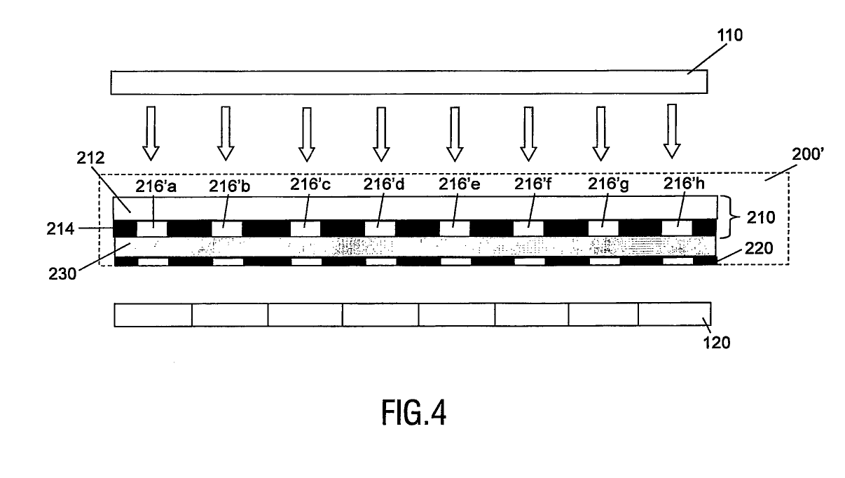

As an alternative to an opaque layer with empty pits, as indicated in FIG. 4, the information layer 214 may contain a fluorescent dye in an array of pits (216′a, 216′b, 216′c etc). In such an instance, the light source 110 would be arranged to provide light at a wavelength λ₁ sufficient to excite the fluorescent material. As the material fluoresces, it would emit light at a longer (lower energy) wavelength λ₂. This longer wavelength light λ₂ would be detected by the image sensor 120, once the near-field of the emitted light had been imaged by the respective optical aperture. In such an instance, the separation between the layers 210 and 220 should be less than the wavelength of the emitted light i.e. less than λ₂. Information could again be stored by varying the presence and/or size of the pits, or the concentration of fluorescent material in each pit.

Alternatively, instead of using pits, each data area could correspond to a small reflector. The information layer 210 could be illuminated from the side i.e. from the direction parallel with the planar surface of the information layer. The apertures in the readout layer would be arranged to image the near-field of the reflected light from a respective reflector. The presence or absence of the reflected light would again indicate the relevant information.

As shown in FIG. 4, as an enhancement to any of the embodiments of the present invention, the gap between the information layer 210 and the readout layer 220 could be filled with a material 230 with a refractive index at the emitted wavelength (i.e. λ or λ₂) greater than 1. Use of a material having a refractive index, n>1 allows the use of even smaller apertures and pits, without a loss of transmission efficiency, thereby enabling higher information densities on the information layer.

The information can be written to the information layer upon manufacture of the information storage unit (200, 200′). Alternatively, writing means can be provided to write information to the information layer whilst in situ, by providing data areas that have optical properties that can be modified by a predetermined process. For instance, data area on the information layer could be modifiable using similar processes to that used to write to writeable and rewriteable CD-ROMs.

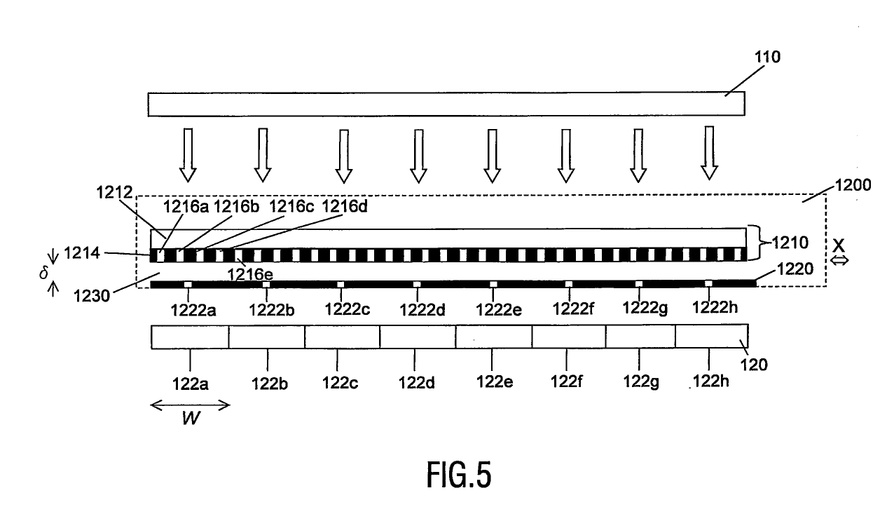

FIG. 5 illustrates a cross sectional view of a card and a reader in accordance with a third embodiment of the present invention.

It will be observed that the card 1200 comprises an information layer 1210 and a readout layer 1220. As previously, the information layer 1210 comprises a transparent layer 1212 and an optically opaque layer 1214.

The reader 100 comprises a light source 110 and an optical sensor 120. The optical sensor comprises an array of light sensing areas, each area being of width W.

The readout layer comprises a plurality of apertures (1222a, 1222b, 1222c, . . . ), with one aperture per width W of the readout layer. In this particular embodiment, the overall width of the optical sensor 120 is the same as the overall width of the readout layer 1220, such that each aperture in the readout layer corresponds to a respective light sensing area (122a, 122b, 122c, . . . ) of the optical sensor 120.

The significant difference between this particular embodiment and the previous embodiment is that there are a plurality of data areas 1216a, 1216b, 1216c for each aperture 1222 in the readout layer 1220. The apertures in the readout layer are of a similar size to the data areas. Preferably the spacing δ is slightly smaller than this size, to avoid different apertures in the readout layer simultaneously imaging the same data area. Preferably, the size (i.e. width, length, or diameter) of the data areas, the size of the apertures in the readout layer and the separation between the readout layer and the information layer are all of the order of or slightly smaller than, the wavelength, such that the device operates in the near-field coupling regime.

In this particular embodiment, the information layer 1210 is moveable relative to both the readout layer 1220 and the image sensor 120. This can be achieved by holding the information layer stationary, and moving both the readout layer 1220 and the optical sensor 120, or more preferably by holding the readout layer 1220 and the optical sensor 120 stationary, and moving the information layer 1210 within a plane parallel to the readout layer 1220 (e.g. within the direction indicated by the arrows X).

This movement will cause the apertures 1222 to image different data areas, and consequently the light sensing areas to detect light from different data areas. For instance, initially, the alignment of the data areas with the apertures of the readout layer could be such that data area 1216b is imaged by aperture 1222a, with the light from the aperture being detected by the corresponding light sensing area 122a. However, if the information layer 1210 is moved slightly to the left, then aperture 1222a will image data area 1216c (and again, the corresponding light sensitive area 122a detects the light imaged by the corresponding aperture 1222a).

This movement can be achieved by movement means, such as a piezo-electric actuator, which can be within the card, but is more preferably within the reader.

Preferably, the data areas are spaced an integral fraction of the spacing of the apertures in the readout layer. In the embodiment shown in FIG. 5, there is one aperture per distance W in the readout layer, and so there are correspondingly l data areas per distance W in the information layer 1210, where l is any integer (and in this particular example, l=4). Assuming that the data areas 1216, the apertures 1222, and the light sensing areas 122 are regularly spaced, this will allow information to be collected in parallel from the data areas by the optical sensor.

For instance, in the example shown in FIG. 5, if the first data area 1216a is being imaged by the first aperture 1222a, and detected by optical sensing area 122a, then the fifth data area 1216e will simultaneously be imaged by the second aperture 1222b and detected by corresponding optical sensor area 122b, the ninth data area aligned with the third aperture 1222c etc. Thus, by transversely moving the information area 1210 by a distance W (such that data areas 1216a, 1216b, 1216c and 1216d are in turn imaged by readout aperture 1222a) all of the data areas can be scanned by a respective readout aperture and the corresponding light sensing area.

In this above example, only a line of data areas/light sensing areas and apertures has been considered. However, assuming that a regular 2D array of such apertures, data areas and light sensing areas exist, each lying within the x-y plane, then simply by moving the information layer 1210 in the x plane by a distance W and successively in the y plane by a distance W/n for n times, it is possible to scan all of the data areas in the information layer 1210.

It will be appreciated that a reader as herein described, or an information storage unit incorporating such a reader, could be utilized in any information processing system i.e. in any device in which information might need to be written to a storage unit, or read from a storage unit. For instance, such information processing systems would include computers, music playing systems, image reproducing systems, data storage systems etc.

By providing an optical information storage unit in which the readout layer is arranged to allow imaging substantially only of the near-field of light emitted from a respective data area, diffraction effects associated with the far-field interaction of light from the data area do not occur, and thus a high density information storage unit can be formed. Further, as the imaging of the near-field of light intrinsically means that the readout layer is positioned in close proximity to the information layer (i.e. without a convoluted optical imaging path), then a compact optical storage unit can be formed.

1. An optical information storage unit comprising:
an information layer comprising a plurality of data areas, each data area being arranged to emit light when illuminated by light at a predetermined wavelength; and
a readout layer comprising a plurality of optical apertures, each optical aperture being arranged to image substantially only the near field of light emitted from a respective data area.

2. An information storage unit as claimed in claim 1, where both the readout layer and the information layer are planar and substantially parallel, the separation between the information layer and the readout layer being less than the wavelength of emitted light.

3. An information storage unit as claimed in claim 1, wherein the information layer is movable within a plane substantially parallel to the readout layer.

4. An information storage unit as claimed in claim 1, wherein said information layer has a data areas per unit area, and said readout layer has b optical apertures per unit area, where a>b.

5. An information storage unit as claimed in claim 1, wherein each data area comprises an optical aperture, the light emitted from each data area when illuminated corresponding to light transmitted through the aperture.

6. An information storage unit as claimed in claim 1, wherein each data area comprises a reflector, the light emitted from each data area comprising light reflected from the reflector when the respective data area is illuminated.

7. An information storage unit as claimed in claim 1, wherein each area comprises a fluorescent material, the light emitted from each data area comprising the light emitted by the material as it fluoresces, the illuminating light acting to excite the fluorescent material.

8. An information storage unit as claimed in claim 1, wherein an optically transmissive material is placed between the information layer and the readout layer, the optically transmissive material having a refractive index greater than 1 at the wavelength of the emitted light.

9. An optical information storage unit as claimed in claim 1, wherein at least one of said data areas is modifiable by a predetermined process so as to alter the optical characteristics of the data area such that the intensity of light emitted by the data area when illuminated will be altered.

10. An information storage unit as claimed in claim 1, the unit further comprising:
a light source arranged to provide light at the predetermined wavelength for illumination of the data areas; and
an optical sensor comprising a plurality of light sensing areas, the optical sensor being arranged to detect the near field of light imaged by each respective optical aperture.

11. A reader for an optical information storage unit, the reader being arranged to removably receive an optical information storage unit as claimed in claim 1, the reader comprising:
a light source arranged to provide light at the predetermined wavelength for illumination of the data areas; and
an optical sensor comprising a plurality of light sensing areas, the optical sensor being arranged to detect the near field of light imaged by a respective optical aperture.

12. A reader as claimed in claim 11, further comprising writing means arranged to controllably alter the optical properties of the data areas, so as to write data to the data areas.

13. A reader as claimed in claim 11, further comprising movement means arranged to move the position of the information layer relative to the position of both the readout layer and the optical sensor.

14. An information processing system comprising at least one of:
an optical information storage unit as claimed in claim 10.

15. A method of reading information from an optical information storage unit, the information storage unit comprising:
an information layer comprising a plurality of data areas, each data area being arranged to emit light when illuminated by the light at a predetermined wavelength; and a readout layer comprising a plurality of optical apertures, each optical aperture being arranged to image substantially only the near field of light emitted from a respective data area; the method comprising:
illuminating at least one data area with light at the predetermined wavelength; and
detecting the optical intensity of light imaged by the respective optical aperture that corresponds to the illuminated data area.

16. A method of reading information from an optical information storage unit as claimed in claim 15, the method further comprising the step of:
moving the information layer within a plane substantially parallel to the readout layer, such that an optical aperture previously imaging a first data area images a second, different data area within the information layer.

17. A method of manufacturing an optical information storage unit, the method comprising the steps of: providing an information layer comprising a plurality of data areas, each data area being arranged to emit light when illuminated by light at a predetermined wavelength; and
providing a readout layer comprising a plurality of optical apertures, the readout layer being located at a distance from the information layer such that each optical aperture is arranged to image substantially only the near field of light emitted from a respective data area.

18. A method of writing data to an optical information storage unit, the information storage unit comprising an information layer comprising a plurality of data areas, each data being modifiable so as to emit light when illuminated by the light of predetermined wavelength, and a readout layer comprising a plurality of optical apertures, each optical aperture being arranged to image substantially only the near field light emitted from the respective data area; the method comprising:
selectively modifying at least one data area so as to emit light at a predetermined intensity when illuminated, the predetermined intensity being indicative of the information stored by the respective data area.

19. A method of manufacturing a reader for an optical information storage unit, the method comprising:
providing a locator unit arranged to removably receive an optical information storage unit as claimed in claim 1;
providing a light source arranged to provide light at the predetermined wavelength for illumination of the data areas of the storage unit; and
providing an optical sensor comprising a plurality of light sensing areas, the optical sensor being arranged to detect the near field of light imaged by each respective optical aperture of the storage unit.
